(19) United States
(12) Patent Application Publication
(10) Pub. No.: US 2005/0052579 A1
(43) Pub. Date: Mar. 10, 2005

(54) Television tuner having circuit for attenuating FM broadcasting band

(75) Inventor: Masaki Yamamoto, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/913,776

(22) Filed: Aug. 6, 2004

(30) Foreign Application Priority Data
Aug. 18, 2003 (JP) 2003-270595

(51) Int. Cl. H04N 5/60; H04N 5/44

(52) U.S. Cl. 348/736

(57) ABSTRACT

A television tuner includes (i) an FM trapping circuit including a parallel resonance circuit that resonates to an FM broadcasting band and a first switching diode which is connected in parallel to the parallel resonance circuit; and (ii) a switching transistor for controlling the on/off state of the first switching diode. The collector of the switching transistor is connected to a power source via a pull-up resistor, and the emitter thereof is grounded. A predetermined forward bias voltage is applied to the anode of the switching diode, the cathode thereof is connected to the collector of the switching transistor via another resistor, and a switching voltage for turning on/off the switching transistor is applied to the base of the switching transistor.

### BACKGROUND OF THE INVENTION

1. Field of the Invention

The present invention relates to a television tuner having an FM trapping circuit for attenuating an FM broadcasting band.

2. Description of the Related Art

There is a known television tuner in which an FM trapping circuit for attenuating an FM broadcasting band is provided in the input section of the television tuner, and the FM trapping circuit is switched to activate or deactivate as necessary so as to be capable of being used to receive a conventional terrestrial television broadcast or a cable television broadcast.

FIG. 4 shows the configuration of such a television tuner. A filter circuit 32 for attenuating an intermediate frequency band, etc., is connected to an antenna connection terminal 31. An FM trapping circuit 33 is provided at the stage subsequent to the filter circuit 32. The FM trapping circuit 33 includes an inductance element 33a and a capacitor element 33b, which constitute a parallel resonance circuit that resonates to an FM broadcasting band; and a first switching diode 33c which is connected in parallel to the parallel resonance circuit via a DC cutting capacitor element. Consequently, the FM trapping circuit 33 is activated when the first switching diode 33c is off and is deactivated when it is on.

An input tuning circuit 34 for a VHF band is provided at the stage subsequent to the FM trapping circuit 33. The band-switching-type input tuning circuit 34 includes a plurality of tuning inductance elements 34a to 34d, which are connected in series with each other; a second switching diode 34e which is connected across the two inductance elements 34b and 34c; a first varactor diode 34f which, together with the inductance elements 34a to 34d, constitutes a parallel tuning circuit; and a bias circuit 34g, which is formed of voltage-dividing resistors R1 and R2, for dividing a power-supply voltage Vcc and for applying a forward bias voltage to the anode of the second switching diode 34e. Then, the input tuning circuit 34 is switched to tune to a high band/low band of the VHF band according to the on/off state of the second switching diode 34e. A VHF high-frequency amplifier 36 is coupled to the input tuning circuit 34 via a second varactor diode 35.

Furthermore, an input tuning circuit 38 for a UHF band is connected to the FM trapping circuit 33 via a third switching diode 37. A UHF high-frequency amplifier 39 is connected at the stage subsequent to the input tuning circuit 38. Then, the third switching diode 37 is turned on when a UHF-band television signal is received.

The anode of the first switching diode 33c in the FM trapping circuit 33, together with the anode of the third switching diode 37, is connected to the connection point the inductance elements 34b and 34c in the input tuning circuit 34, with the result that a forward bias voltage is applied from the bias circuit 34g to each anode of the two switching diodes 33c and 37.

Each cathode of the first to third switching diodes 33c, 34e, and 37 is connected to a switching circuit 40 for controlling the on/off state of these cathodes. The switching circuit 40 is formed as an integrated circuit, and two switching transistors 40a and 40b are formed therein. The first switching transistor 40a controls the on/off state of the first switching diode 33c, a power-supply voltage is applied to the collector thereof, and a switching voltage is applied to the base thereof. Then, the cathode of the first switching diode 33c is grounded via a resistor R3 and is connected to the emitter of the first transistor 40a via a resistor R4. The resistors R3 and R4 function as voltage-dividing resistors for applying a reverse bias voltage for turning off the first switching diode 33c when the first transistor 40a is on.

The second switching transistor 40b controls the on/off state of the second and third switching diodes 34e and 37, a power-supply voltage is applied to the collector thereof via a pull-up resistor R5, the emitter thereof is grounded, and a switching voltage is applied to the base thereof. Then, the cathode of the second switching diode 34e is connected to the collector of the switching transistor 40b via a resistor R6, and the cathode of the third switching diode 37 is connected to the collector of the switching transistor 40b via a resistor R7.

In the above-described configuration, in order to activate the FM trapping circuit 33, the first transistor 40a is turned on. Just then, as shown in FIG. 5, the first switching diode 33c is turned off as a result of a reverse bias voltage from the voltage-dividing resistors R3 and R4 being applied to the cathode of the switching diode 33a. The reverse bias voltage is higher than the forward bias voltage.

Furthermore, in order to deactivate the FM trapping circuit 33, the first switching transistor 40a is turned off. Just then, as shown in FIG. 6, since the cathode of the first switching diode 33c is grounded only by the resistor R3, the first switching diode 33c is turned on.

In the above-described configuration, the cathode of the first switching diode 33c is connected to the emitter of the first switching transistor 40a via the resistor R4 and is grounded via the resistor R3. Since the first switching diode 33c is biased in a reverse direction by the divided voltage obtained by the resistors R3 and R4, a problem arises in that the voltage cannot be made sufficiently high, and another problem is that, in order that the switching diode is turned on, the resistor R3 connected to the cathode of the first switching diode 33c is required.

### SUMMARY OF THE INVENTION

An object of the present invention is to apply a bias voltage for turning on/off the switching diode of an FM trapping circuit with a simple circuit, and to reduce the inter-terminal capacitance by increasing the reverse voltage for turning off the switching diode.

To achieve the above-mentioned object, in one aspect, the present invention provides a television tuner including: (i) an FM trapping circuit including a parallel resonance circuit that resonates to an FM broadcasting band; and a first switching diode which is connected in parallel to the parallel resonance circuit; and (ii) a switching transistor for controlling the on/off state of the first switching diode, wherein the collector of the switching transistor is connected to a power source via a pull-up resistor, the emitter of the switching transistor is grounded, a predetermined forward bias voltage is applied to the anode of the first switching diode, the cathode of the switching transistor is connected to the collector of the switching transistor via a resistor, and a switching voltage for turning on/off the switching transistor is applied to the base of the switching transistor. Therefore, when the first switching diode is to be turned off, a sufficient reverse bias voltage can be applied to the cathode thereof.

Preferably, a band-switching-type input tuning circuit is provided at the stage subsequent to the FM trapping circuit, a second switching diode for switching the band and a bias circuit for applying a forward bias voltage to the anode of the second switching diode are provided in the input tuning circuit, and a forward bias voltage is supplied from the bias circuit to the anode of the first switching diode. Therefore, the bias circuit provided in the input tuning circuit can be commonly used for both the first and second switching diodes.

Preferably, the input tuning circuit has a tuning inductance element, and the forward bias voltage is applied from the bias circuit to the anode of the first switching diode via the inductance element. Therefore, a forward bias voltage can be easily applied to the second switching diode.

Preferably, the switching transistor and the pull-up resistor are formed within the same integrated circuit. Therefore, by only connecting the cathode of the first switching diode to the collector of the switching transistor via a resistor, the first switching diode can be turned on/off.

### BRIEF DESCRIPTION OF THE DRAWINGS

FIG. 1 is a circuit diagram showing the configuration of a television tuner according to the present invention;

FIG. 2 is a DC circuit diagram when a switching diode of an FM trapping circuit in the television tuner of the present invention is turned off;

FIG. 3 is a DC circuit diagram when the switching diode of the FM trapping circuit in the television tuner of the present invention is turned on;

FIG. 4 is a circuit diagram showing the configuration of a conventional television tuner;

FIG. 5 is a DC circuit diagram when a switching diode of an FM trapping circuit in the conventional television tuner is turned off; and

FIG. 6 is a DC circuit diagram when the switching diode of the FM trapping circuit in the conventional television tuner is turned on.

### DESCRIPTION OF THE PREFERRED EMBODIMENT

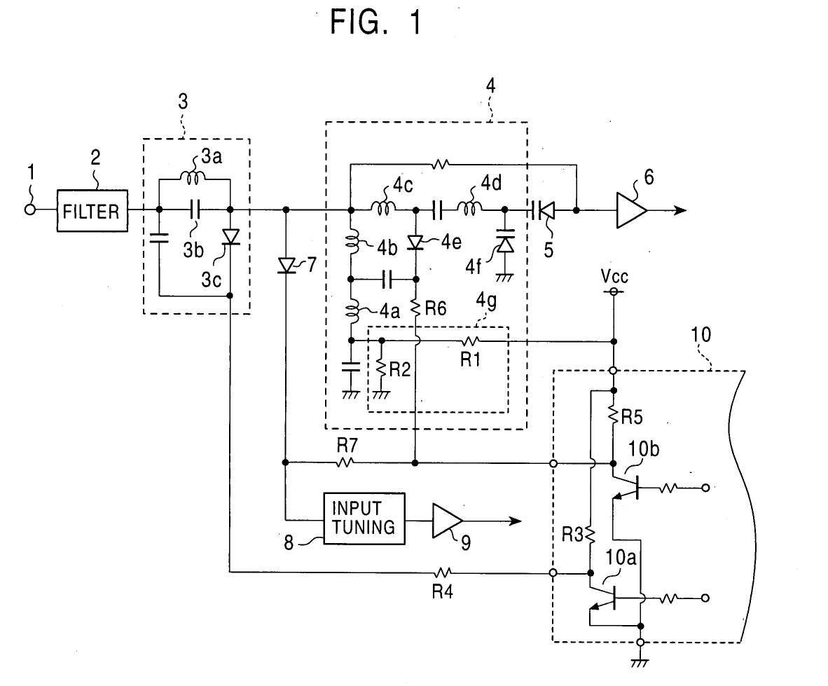

FIG. 1 shows the configuration of a television tuner according to the present invention. A filter circuit 2 for attenuating an intermediate frequency band, etc., is connected to an antenna connection terminal 1. An FM trapping circuit 3 is provided at the stage subsequent to the filter circuit 2. The FM trapping circuit 3 includes an inductance element 3a and a capacitor element 3b, which constitute a parallel resonance circuit that resonates to an FM broadcasting band; and a first switching diode 3c which is connected in parallel to the parallel resonance circuit via a DC cutting capacitor element. Consequently, the FM trapping circuit 3 is activated when the first switching diode 3c is off and is deactivated when the first switching diode 3c is on.

An input tuning circuit 4 for a VHF band is provided at the stage subsequent to the FM trapping circuit 3. The band-switching-type input tuning circuit 4 includes a plurality of tuning inductance elements 4a to 4d, which are connected in series with each other; a second switching diode 4e which is connected across the two inductance elements 4b and 4c; a first varactor diode 4f which, together with the inductance elements 4a to 4d, constitutes a parallel tuning circuit; and a bias circuit 4g, which is formed of voltage-dividing resistors R1 and R2, for dividing a power-supply voltage Vcc and for applying a bias voltage to the anode of the second switching diode 4e. A VHF high-frequency amplifier 6 is coupled to the input tuning circuit 4 via a second varactor diode 5.

Then, the input tuning circuit 4 is switched to tune to a high band/low band of the VHF band according to the on/off state of the second switching diode 4e.

Furthermore, an input tuning circuit 8 for a UHF band is connected to the FM trapping circuit 3 via a third switching diode 7. A UHF high-frequency amplifier 9 is connected at the stage subsequent to the input tuning circuit 8. Then, the third switching diode 7 is turned on when a UHF-band television signal is received.

The anode of the first switching diode 3c in the FM trapping circuit 3, together with the anode of the third switching diode 7, is connected to the connection point of the inductance elements 4b and 4c in the input tuning circuit 4, with the result that a bias voltage is applied from the bias circuit 4g to the anodes.

Each cathode of the first to third switching diodes 3c, 4e, and 7 is connected to a switching circuit 10 for controlling the on/off state of these cathodes. The switching circuit 10 is formed as an integrated circuit, and two switching transistors 10a and 10b, two pull-up resistors R3 and R5, etc., are formed therein. The first switching transistor 10a controls the on/off state of the first switching diode 3c, a power-supply voltage is applied to the collector thereof via the pull-up resistor R3, and the emitter thereof is grounded. Furthermore, a switching voltage is applied to the base thereof. Then, the cathode of the first switching diode 3c is connected to the collector of the first transistor 10a via a resistor R4.

The second switching transistor 10b controls the on/off state of the second and third switching diodes 4e and 7, a power-supply voltage is applied to the collector thereof via a pull-up resistor R5, the emitter thereof is grounded, and a switching voltage is applied to the base thereof. Then, the cathode of the second switching diode 4e is connected to the collector of the second switching transistor 10b via a resistor R6, and the cathode of the third switching diode 7 is connected to the collector of the second switching transistor 10b via a resistor R7.

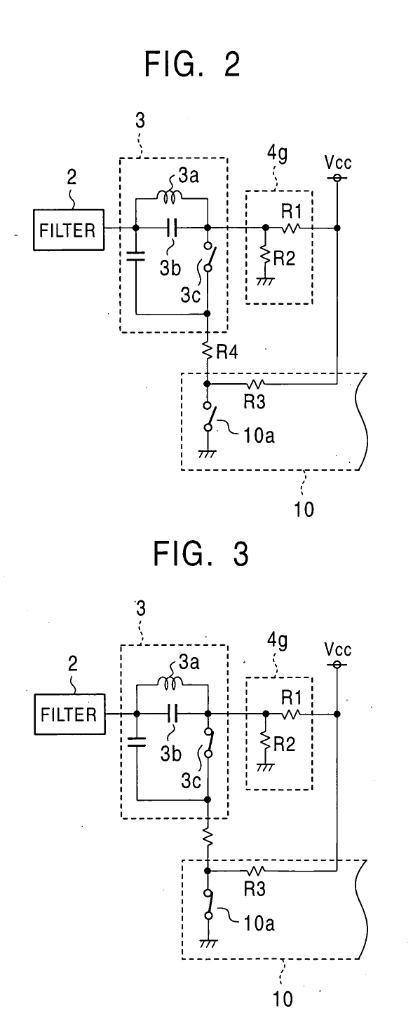

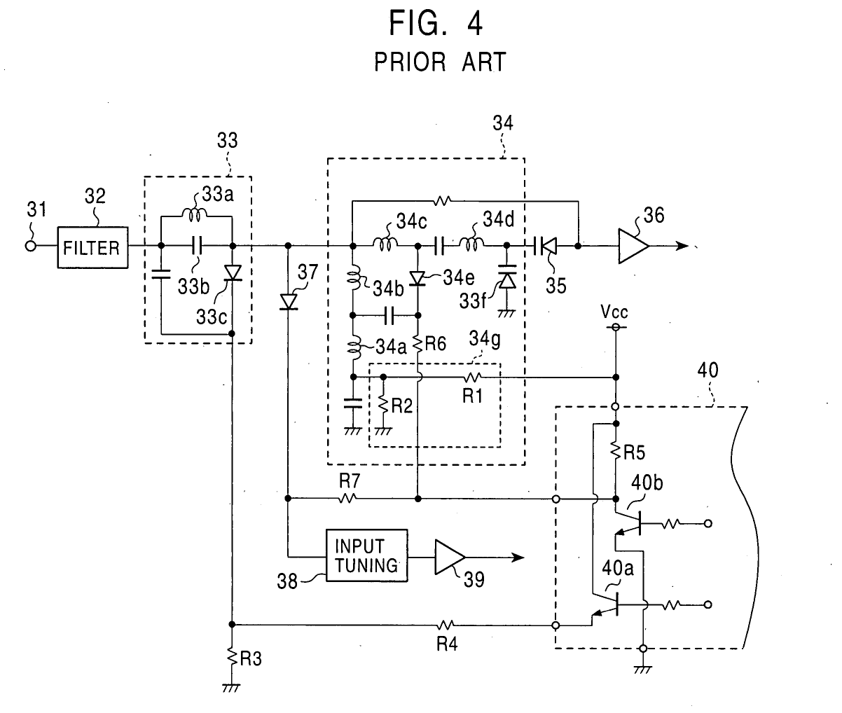

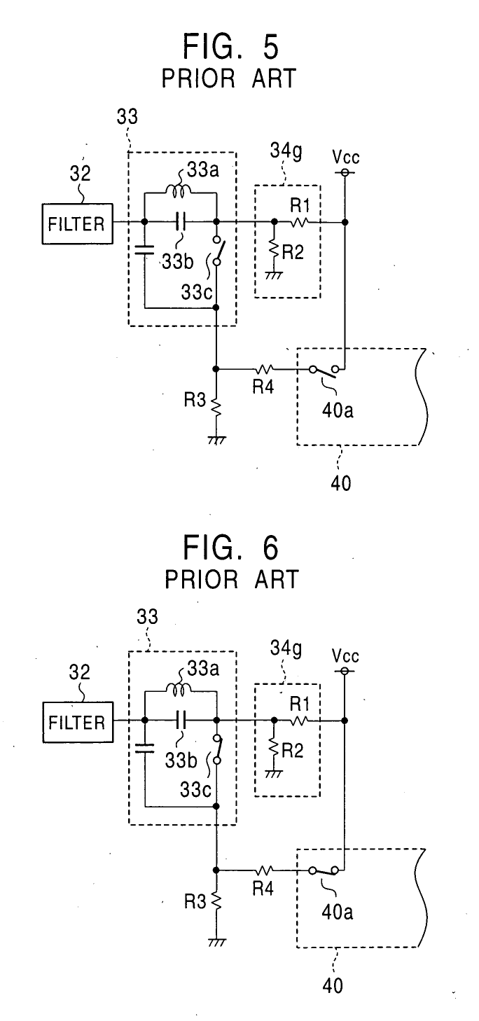

In the above-described configuration, in order to activate the FM trapping circuit 3, the first switching transistor 10a is turned off. Just then, as shown in FIG. 2, the first switching diode 3a is turned off as a result of the cathode thereof being biased by a reverse voltage from the power-supply voltage via the resistors R3 and R4, which are connected in series. As a result, since a sufficient reverse bias voltage is applied, the value of the inter-terminal capacitance becomes smaller, and the FM trapping circuit is activated satisfactorily.

Furthermore, in order to deactivate the FM trapping circuit 33, the first switching transistor 10a is turned on. Just then, as shown in FIG. 3, the first switching diode 3c is turned on because the cathode thereof is grounded only by the resistor R4.

1. A television tuner comprising:
an FM trapping circuit comprising:
a parallel resonance circuit that resonates to an FM broadcasting band; and
a first switching diode which is connected in parallel to said parallel resonance circuit; and
a switching transistor for controlling an on/off state of said first switching diode,
wherein a collector of said switching transistor is connected to a power source via a pull-up resistor, an emitter of the switching transistor is grounded, a predetermined forward bias voltage is applied to an anode of said switching diode, a cathode of the switching diode is connected to the collector of said switching transistor via a resistor, and a switching voltage for turning on/off the switching transistor is applied to a base of said switching transistor.

2. The television tuner according to claim 1, wherein a band-switching-type input tuning circuit is provided at a stage subsequent to said FM trapping circuit,
a second switching diode for switching the band and a bias circuit for applying a forward bias voltage to an anode of said second switching diode are provided in said input tuning circuit, and
a forward bias voltage is supplied from said bias circuit to the anode of said first switching diode.

3. The television tuner according to claim 2, wherein said input tuning circuit has a tuning inductance element, and said forward bias voltage is applied from said bias circuit to the anode of said first switching diode via said inductance element.

4. The television tuner according to claim 1, wherein said switching transistor and said pull-up resistor are formed within the same integrated circuit.
